(19) United States
(12) Patent Application Publication
(10) Pub. No.: US 2003/0042261 A1
(43) Pub. Date: Mar. 6, 2003

(54) Motorcycle gas tank having a lockable compartment

(76) Inventor: David M. Cantor, Paradise Valley, AZ (US)

Correspondence Address: Squire, Sanders & Dempsey, L.L.P., 14th Floor, 801 S. Figueroa Street, Los Angeles, CA, 90017-5554, US

(21) Appl. No.: 10/230,620

(22) Filed: Aug. 29, 2002

Related U.S. Application Data
(60) Provisional application No. 60/316,070, filed on Aug. 29, 2001.

(51) Int. Cl. B60P 3/00; B62D 33/00; B65D 88/12

(52) U.S. Cl. 220/564

(57) ABSTRACT

This invention provides a compartment in a motorcycle gas tank to hold items or articles such as vehicle registration, insurance, tools, sunglasses, gloves and the like. The compartment has an opening that may be enclosed by a cap that may be lockable. The compartment may be releasable from the gas tank so that a rider may take the items in the compartment with the rider for security. The cap may have a key opening that may move or align to a number of different positions such as open the compartment position, lock everything position, and open the gas tank position.

### RELATED APPLICATION(S)

This application claims priority to a provisional application having a serial No. 60/316,070 filed Aug. 29, 2001, which is hereby incorporated by reference into this application.

### BACKGROUND OF THE INVENTION

1. Field of the Invention

This invention relates to a motorcycle gas tank having a lockable compartment.

2. General Background and State of the Art

Motorcycles offer their riders mobility and the sheer pleasure of riding through open air. The motorcycles are, however, smaller than cars and therefore offer very little, if any, storage space. Usually, a duffle bag over the rear wheel of the motorcycle provides enough space to hold small items such as gloves, clothing, sunglasses and the like. Even so, duffle bags do not offer much security in protecting the items because oftentimes there is no locking mechanism and duffle bags are often made of leather so they may be cut open. Accordingly, valuable items such as a driver's license, registration, and insurance information need to be carried by the rider rather than being kept in the duffle bag. Therefore, there is still a need for a motorcycle rider to be able to store valuable items safely with the motorcycle.

### INVENTION SUMMARY

This invention relates to a motorcycle gas tank having a lockable compartment so that items such as vehicle registration, jewelry, and tools may be stored within the compartment. The compartment may be formed from a recess within the gas tank and a lockable cap may be provided to fit over the opening to seal the compartment. Moreover, the compartment may be portable so that the compartment may be removed from the gas tank and carried by the rider when leaving the motorcycle.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a cross-sectional view of a motorcycle gas tank having a recessed compartment.

FIG. 2 is a cross-sectional view of a motorcycle gas tank having an alternative storage compartment.

FIG. 3 is a cross-sectional view of a motorcycle gas tank having an alternative storage compartment.

FIG. 4 is a top view of a locking system capable of operating in three positions.

### DETAILED DESCRIPTION OF THE INVENTION

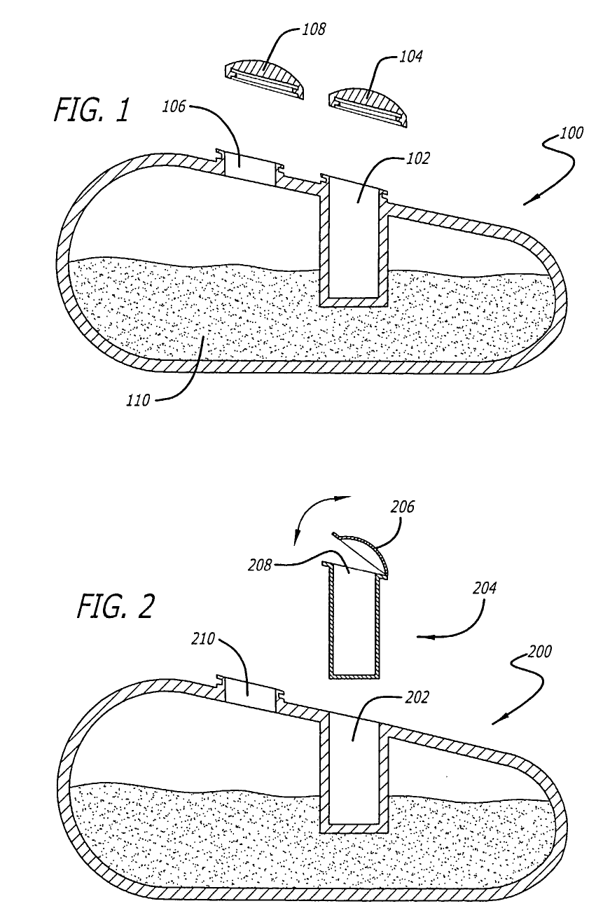

FIG. 1 illustrates a gas tank 100 having a compartment 102 adapted to receive a cap 104 to enclose the compartment 102. The gas tank 100 may also have an opening 106 adapted to receive a nozzle in order to fill the gas tank 100 with fuel 110. A second cap 108 may be provided to close the opening 106 to prevent the fuel 110 from escaping.

The compartment 102 may allow a rider to securely store items such as a driver's license, registration, insurance information, jewelry, mobile phone, and tools within the compartment 102. Once the items are in the compartment 102, the lockable cap 104 may be used to secure the compartment 102. This way, valuable items may be hidden from potential theft. To camouflage the compartment 102, the top side of the cap 104 may appear to look like a readable instrument such as a fuel gauge, speedometer, for example. Alternatively, the cap 104 may be a functioning instrument designed to provide fuel level, engine temperature, speedometer, and the like. This way, others not familiar with the compartment 102 in the tank 100 will unlikely attempt to steal the items in the compartment 102. The cap 104 may be locked to the compartment 102 using a key or using an electronic key pad, or any other methods known to one skilled in the art.

The compartment 102 may be customized to hold any particular item desired by the rider. For example, compartment 102 may be configured to receive a customized tool kit designed to fix the motorcycle in case of a breakdown. The tool kit design may be a cylindrical shape in a carrying position, but may open up like a Swiss army knife with tools to fix simple problems with the motorcycle. The compartment 102 may have an elongated shape opening to hold a book, pens, and the like. Alternatively, compartment 102 may be sized to be slightly bigger than a soda can to function as a cup holder without the cap 104.

FIG. 2 illustrates a gas tank 200 that has a bore 202 adapted to receive a compartment 204. The compartment 204 may have a lockable cap 206. The cap 206 may be a separate piece or pivotably coupled to the compartment 204. The cap 206 may enclose or lock the compartment 204. The cap 206 may be adapted to receive a key to lock the compartment or any other method known to one skilled in the art may be used to enclose or lock the compartment 204 with the cap 206. This allows valuable items to be stored in the opening 208 of the compartment 204 and locked with the cap 206. Compartment 204 may be adapted to be inserted into the bore 202 and locked into the bore 202. As such, locking the compartment to the bore 202 of the motorcycle may take two steps. First, the valuable items may be stored within the opening 208 and locked with the cap 206. Second, the entire compartment 204 may be then locked within the bore 202 to securely stow valuable items in the opening 208 within the gas tank 200. Moreover, the gas tank 200 may have an opening 210 to fill the gas tank 200 with fuel. This way, the compartment 204 may be released from the bore 202 so that a rider may take the compartment 204 with the valuable items stored therein with him, if desired.

FIG. 3 illustrates a gas tank 300 having a bore 302 that may serve two functions. First, the bore 302 may be adapted to receive a nozzle from the gas pump in order to fill the gas tank 300 with fuel. Second, the bore 302 may be adapted to receive a compartment 304 to enclose the bore 302. For example, to fill the gas tank 300 with fuel, the entire compartment 304 may be removed from the bore 302 so that a nozzle may be inserted into the bore 302 to fill the gas tank 300 with fuel. Thereafter, compartment 304 may be inserted into the bore 302 to close or lock the bore 302 so that fuel does not escape from gas tank 300. Alternatively, the compartment 304 may include a compartment 306 and a cap 308 that may be inserted into bore 302. The compartment 306 may be independently locked into the bore 302 so that the cap 308 may be removed from the compartment 306, even though the compartment 306 is locked within the gas tank 300. Accordingly, valuable items may be stored within the compartment 306 and securely locked with the cap 308, whether the compartment 306 is inside or removed from the bore 302. Accordingly, this may be a three-way locking system.

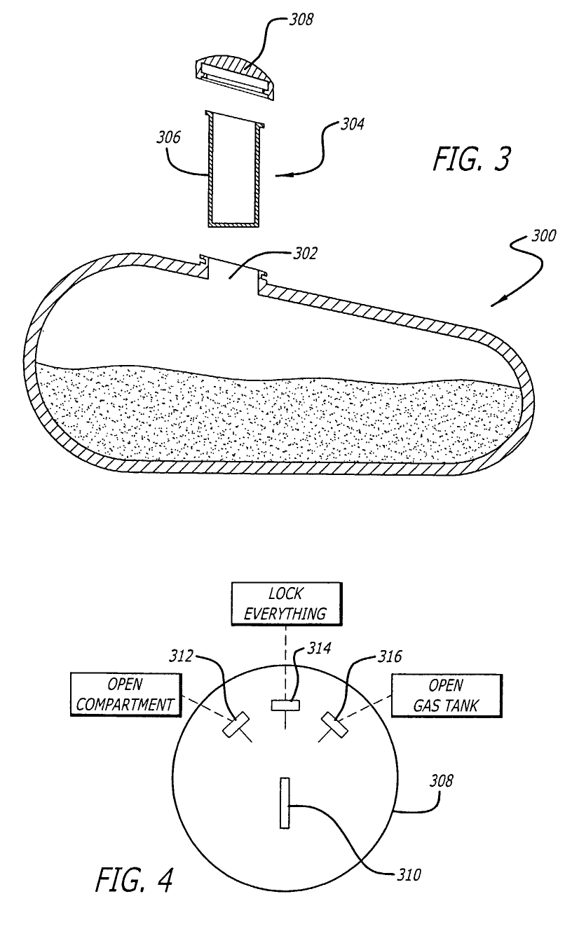

FIG. 4 illustrates a top view of the cap 308 with a key opening 310 adapted to rotate or align with a number of different positions. For example, the key opening 310 may rotate into three positions: a first position 312, a second position 314, and a third position 316. The first position 312 may correspond to an open compartment position; the second position 314 may correspond to a lock-everything position, and the third position 316 may correspond to an open gas tank position. To remove the cap 308 relative to the compartment 306, a key may be inserted into the key opening 310 and rotated in a counter-clockwise direction to the position 312. This allows a rider to insert items into the compartment while the compartment 306 is still locked into the opening 302. Conversely, to lock the compartment 304 into the opening 302, the key may be inserted into the key opening 310 and moved into the center position 314 to lock everything down. To fill the gas tank 300, the key slot 310 may be rotated into the third position 316 to remove the entire compartment 304, so that a nozzle of a gas pump may be inserted into the opening 302 and the gas tank 300 filled with fuel. Accordingly, the embodiment disclosed in FIGS. 3 and 4 describe a three-way locking system.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A motorcycle gas tank having a lockable compartment, comprising:
a gas tank having a disposed compartment, wherein the disposed compartment has an opening adapted to receive an item; and
a cap adapted to enclose the opening of the disposed compartment.

2. The gas tank according to claim 1, where the cap has a functioning instrument.

3. The gas tank according to claim 1, where the disposed compartment is configured to receive a tool.

4. The gas tank according to claim 1, where the gas tank has a second opening adapted to receive a nozzle from a gas pump.

5. The gas tank according to claim 1, where the cap is lockable to the opening of the disposed compartment.

6. The gas tank according to claim 1, where the compartment is configured to serve as a cup holder.

7. A motorcycle gas tank system having a lockable compartment, comprising:
a compartment having an opening adapted to receive at least one item;
a cap adapted to enclose the opening of the compartment; and
a gas tank having a bore adapted to receive the compartment.

8. The system according to claim 7, where the cap is pivotally coupled to the compartment to enclose and lock the opening of the compartment.

9. The system according to claim 7, where the compartment is adapted to lock within the bore of the gas tank.

10. The system according to claim 7, where the cap is adapted to receive a key to lock the cap onto the compartment.

11. The system according to claim 7, where the compartment is releasable from the bore of the compartment.

12. The system according to claim 7, where the cap has a key opening adapted to align with a number of different positions, where one of the different positions is a first position that corresponds to an open compartment position that allows a rider to insert the item into the compartment through the opening while the compartment is locked into the bore of the gas tank.

13. The system according to clam 12, where one of the different positions is a second position that corresponds to an lock everything position that locks the cap and the compartment to the gas tank.

14. The system according to claim 13, where one of the different positions is a third position that corresponds to an open gas tank position that allows a rider to remove the cap and compartment from the bore of the gas tank, whereby a nozzle from a gas pump can be inserted into the bore to fill the gas tank with gas.

15. The system according to claim 14, where the cap has a top side with a non-functioning instrument.

16. The system according to claim 14, where the cap has a top side with a functioning instrument.

17. A method for holding an item within a gas tank of a motorcycle, comprising:
forming a compartment adapted to receive at least one item within a gas tank of a motorcycle; and
enclosing the compartment to hold the at least one item in the compartment.

18. The method according to claim 17, further including:
camouflaging the compartment with a non-functioning instrument.

19. The method according to claim 17, further including:
camouflaging the compartment with a functioning instrument.

20. A method for holding an item within a gas tank of a motorcycle, comprising:
inserting an item through an opening of a compartment;
enclosing the opening of the compartment;
inserting the compartment into a bore formed on a gas tank of a motorcycle; and
locking the compartment to the gas tank of the motorcycle.

21. The method according to claim 20, further including:
removing the compartment from the bore of the gas tank; and
inserting a nozzle from a gas pump into the bore to fill the gas tank with gas.

22. The method according to claim 20, further including:
locking the compartment to the bore of the gas tank; and
removing the cap from the compartment to expose the opening of the compartment.
